(19) United States
(12) Patent Application Publication
(10) Pub. No.: US 2006/0087239 A1
(43) Pub. Date: Apr. 27, 2006

(54) Plasma display panel

(75) Inventor: Sung-Yong Lee, Suwon-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/257,058

(22) Filed: Oct. 25, 2005

(30) Foreign Application Priority Data
Oct. 26, 2004 (KR) 10-2004-0085869

(51) Int. Cl. H01J 17/49

(52) U.S. Cl. 313/587

(57) ABSTRACT

A plasma display panel including a rear substrate, address electrodes arranged on the rear substrate and covered by a lower dielectric layer, and partition walls arranged on the lower dielectric layer to define discharge cells. A front substrate is arranged in parallel with the rear substrate, pairs of sustaining electrodes are arranged on the front substrate, an upper dielectric layer covers the sustaining electrodes, and a protective layer covers the upper dielectric layer. The upper dielectric layer comprises a gap between the pairs of sustaining electrodes within the discharge cells, and a fluorescent layer is arranged in the gap.

### CROSS-REFERENCE TO RELATED PATENT APPLICATIONS

This application claims priority to and the benefit of Korean Patent Application No. 10-2004-0085869, filed on Oct. 26, 2004, which is hereby incorporated by reference for all purposes as if fully set forth herein.

### BACKGROUND OF THE INVENTION

1. Field of the Invention

The present invention relates to a plasma display panel, and more particularly, to a plasma display panel that may prevent a permanent afterimage from forming by including a fluorescent substance on an upper plate.

2. Discussion of the Background

Generally, a plasma display panel (PDP) displays an image using gas discharge. PDPs are becoming increasingly in popular because they have excellent display characteristics such as brightness, viewing angle, etc. In the PDP, a gas discharge occurs between electrodes by applying a DC or AC voltage thereto, and a fluorescent substance is excited by the radiation of ultraviolet rays generated by the gas discharge, and thus emits visible rays.

An example of a conventional surface discharge PDP is shown in FIG. 1 and FIG. 2. In FIG. 2, a front substrate is rotated at an angle of 90° to more easily show the PDP's internal structure.

Referring to FIG. 1 and FIG. 2, the conventional surface discharge PDP includes a rear substrate 10 and a front substrate 20 facing each other.

A plurality of stripe-shaped address electrodes 11 are disposed on an upper surface of the rear substrate 10, and a lower dielectric layer 12 covers the address electrodes 11. A plurality of partition walls 13 are formed at predetermined intervals on the lower dielectric layer 12 in order to prevent electrical and optical interference between discharge cells. Red (R), green (G), and blue (B) fluorescent layers 15 are applied at a predetermined thickness to the inner surfaces of the discharge cells partitioned by the partition walls 13, respectively. A discharge gas such as Ne, Xe, and a mixture thereof is injected into the discharge cells.

The front substrate 20, which is a transparent substrate that transmits visible rays, may be generally made of glass, and it is coupled to the rear substrate 10. Pairs of stripe-shaped sustaining electrodes 21a and 21b are provided on a lower surface of the front substrate 20 in a direction perpendicular to the address electrodes 11. The sustaining electrodes 21a and 21b may be made of a transparent conductive material, such as indium tin oxide (ITO), for transmitting visible rays. Bus electrodes 22a and 22b, which are made of metal and are narrower than the sustaining electrodes 21a and 21b, are provided on a lower surface of the sustaining electrodes 21a and 21b in order to reduce the sustaining electrodes' line resistance. A transparent upper dielectric layer 23 covers the sustaining electrodes 21a and 21b and bus electrodes 22a and 22b. A protective layer 24 covers the upper dielectric layer 23.

In such a structure, a ridge-type dielectric layer may be formed in the upper plate including the front substrate 20, the sustaining electrodes 21a and 21b, the upper dielectric layer 23, and the protective layer 24 for low voltage driving and improved efficiency. Specifically, a part of the upper dielectric layer 23 disposed in a space between the pair of sustaining electrodes 21a and 21b inside the discharge cell may be removed by etching, thereby forming a gap 30 between the sustaining electrodes 21a and 21b in one discharge cell. Consequently, the lower surface of the front substrate 20 is exposed to the gap 30.

However, in this structure, since the fluorescent layer 15 is formed inside the discharge cell surrounded by the partition walls 13, that is, on the lower plate including the rear substrate 10, the fluorescent layer 15 may deteriorate due to ion impact during addressing or sustain discharge.

Further, since the fluorescent layer 15 is formed on the lower plate, a permanent afterimage may be formed in the PDP.

### SUMMARY OF THE INVENTION

The present invention provides a plasma display panel of a ridge structure, capable of preventing a permanent afterimage and increasing brightness and efficiency by arranging a fluorescent layer in a gap formed in an upper dielectric layer.

Additional features of the invention will be set forth in the description which follows, and in part will be apparent from the description, or may be learned by practice of the invention.

The present invention discloses a PDP including a rear substrate, address electrodes arranged on the rear substrate and extending in a first direction, a lower dielectric layer covering the address electrodes, partition walls arranged on the lower dielectric layer to define discharge cells, a front substrate arranged substantially in parallel with the rear substrate, pairs of sustaining electrodes arranged on the front substrate and extending in a second direction that crosses the first direction, an upper dielectric layer covering the sustaining electrodes, a protective layer covering the upper dielectric layer, and discharge gas in the discharge cells. The upper dielectric layer comprises a gap between the pairs of sustaining electrodes within the discharge cells, and a fluorescent layer is arranged in the gap.

The present invention also discloses a PDP including a rear substrate, a front substrate coupled with the rear substrate, and a plurality of discharge cells between the front substrate and the rear substrate. A discharge cell includes an address electrode, a sustain electrode pair, and a fluorescent layer. The fluorescent layer is arranged on the front substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a conventional PDP including an upper plate with a ridge structure.

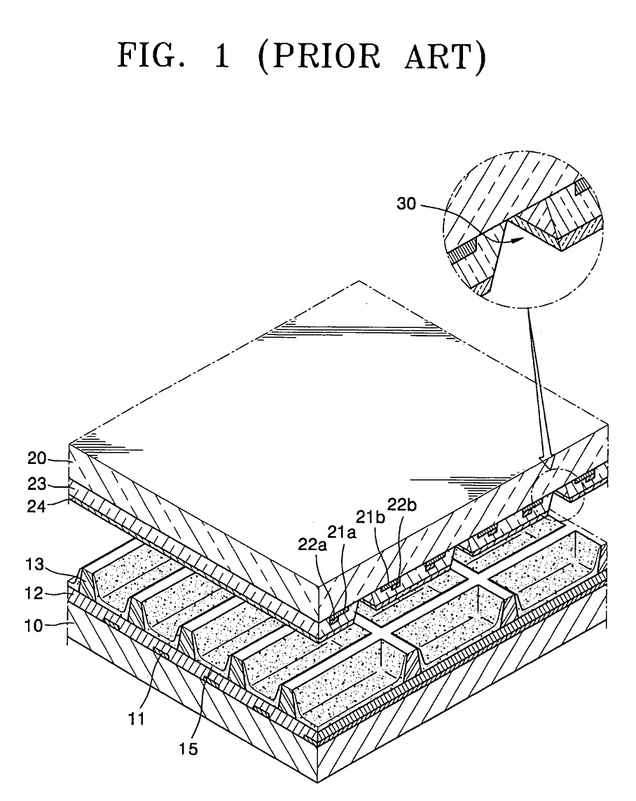

FIG. 2 is an exploded sectional view of the PDP of FIG. 1.

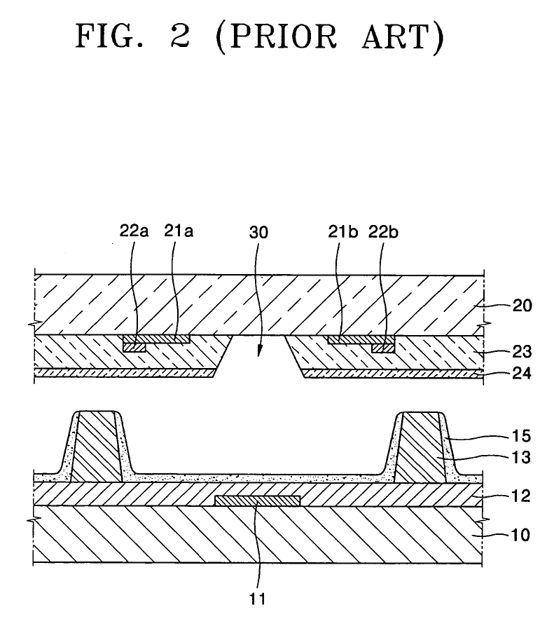

FIG. 3 is an exploded perspective view of a PDP including an upper plate having a ridge structure according to an exemplary embodiment of the present invention.

FIG. 4 is an exploded sectional view of the PDP of FIG. 3.

FIG. 5 is a perspective view of the upper plate along line I-I′ of FIG. 4.

FIG. 6 is an exploded perspective view of a PDP including an upper plate having a ridge structure according to another exemplary embodiment of the present invention.

FIG. 7 is a perspective view of the upper plate along line II-II′ of FIG. 6.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

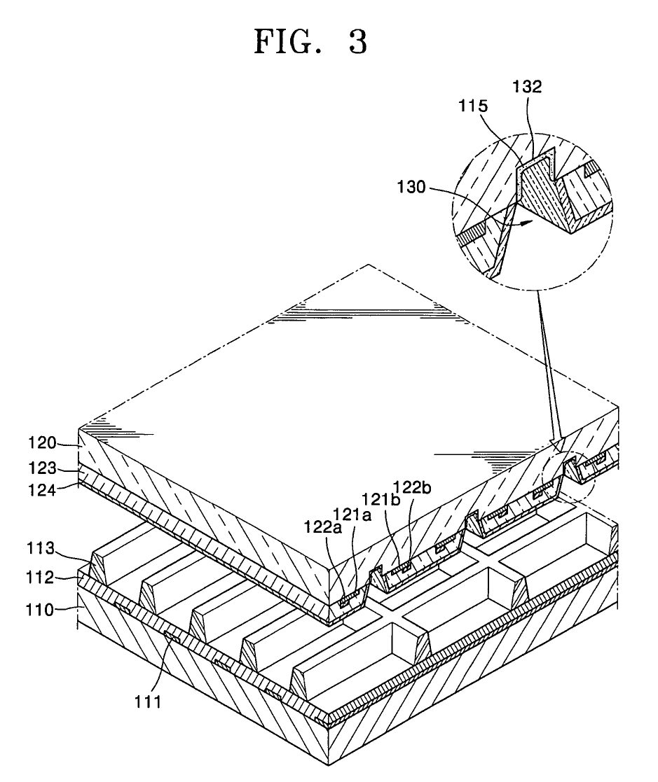

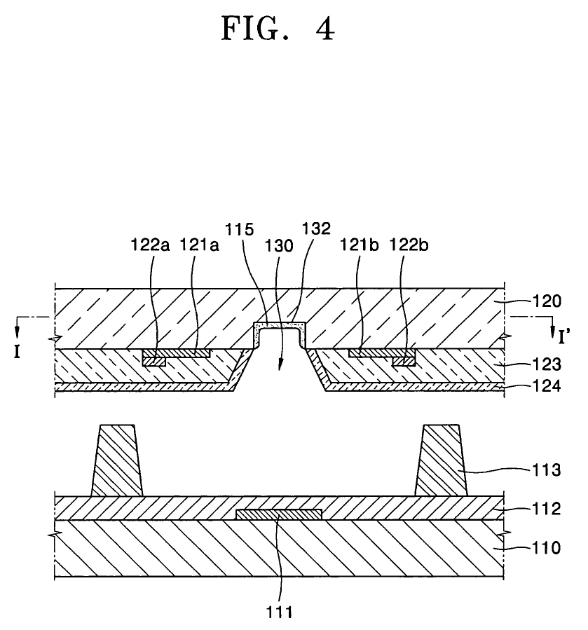

FIG. 3 is an exploded sectional view of a PDP including an upper plate having a ridge structure according to a first exemplary embodiment of the present invention, and FIG. 4 is an exploded sectional view of the PDP of FIG. 3. In FIG. 4, the front substrate is shown rotated at an angle of 90° to better show the PDP's internal structure.

The PDP according to the first embodiment of the present invention includes a rear substrate 110, a plurality of address electrodes 111 arranged on the rear substrate 110, and a lower dielectric layer 112 covering the address electrodes 111. Further, partition walls 113 are arranged on the lower dielectric layer 112. The partition walls 113 partition a discharge space into discharge cells, and they may prevent electrical and optical interference between the discharge cells.

A front substrate 120 is coupled with the rear substrate 110 to form the discharge space, and a pair of sustaining electrodes 121a and 121b are arranged on the lower surface of the front substrate 120. The sustaining electrodes 121a and 121b are formed in strips arranged in a direction crossing the address electrodes 111. Therefore, a pair of sustaining electrodes 121a and 121b and an address electrode 111 are arranged in each discharge cell.

The sustaining electrodes 121a and 121b may be made of a transparent material, such as indium tin oxide (ITO), for transmitting visible rays. However, since transparent material, such as ITO, typically has high resistance, metallic bus electrodes 122a and 122b are formed on lower surfaces of the sustaining electrodes 121a and 121b. The bus electrodes 122a and 122b are narrower than the sustaining electrodes 121a and 121b. The upper transparent dielectric layer 123 covers the sustaining electrodes 121a and 121b and bus electrodes 122a and 122b. Therefore, the sustaining electrodes 121a and 121b and bus electrodes 122a and 122b are not exposed directly to the discharge space.

Since a part of the upper dielectric layer 123 may be removed by etching, the resultant surface has a ridge structure. More specifically, a part of the upper dielectric layer 123 between the pair of sustaining electrodes 121a and 121b may be etched to form a gap 130. Consequently, a part of the lower surface of the front substrate 120 may be exposed. There is no need to vertically etch the upper dielectric layer 123. In other words, the gap need not expose the front substrate 120. It is sufficient for the un-etched surface to protrude relatively further than the etched surface and form a ridge shape.

R, G, and B fluorescent layers 115 may be individually arranged on the lower surface of the front substrate 120 where a part of the upper dielectric layer 123 is removed. Particularly, the lower surface of the front substrate 120 exposed to the gap 130 may be formed in the shape of a groove 132. The groove 132 may be formed having a substantially rectangular or square shape.

The groove 132 may be smaller than, and located within, the discharge cell. Further, the groove 132 is formed with a predetermined depth such that the fluorescent layer 1 15 of a predetermined thickness may be applied to an inner surface of the groove 132. It is also preferable that the size of the groove 132 be such that the fluorescent layer 115 applied to side surfaces of the groove 132 has a predetermined height, in case that the fluorescent layer 115 is applied to both the lower surface and the side surfaces of the groove 132. Furthermore, it is preferable that the fluorescent layer 115 formed on the inner lower surface of the groove 132 and the fluorescent layer 115 formed on the side surfaces of the groove 132 be formed integrally with each other.

A protective layer 124 covers the upper dielectric layer 123. In this case, the protective layer 124 covers a surface of the upper dielectric layer 123 facing the rear substrate 110, as well as surfaces of the upper dielectric layer 123 forming the gap 130. The protective layer 124 prevents the upper dielectric layer 123 from being damaged due to sputtering of plasma particles and decreases a discharge voltage and a sustaining voltage by emitting secondary electrons. The protective layer 124 may be made of magnesium oxide (MgO).

A space surrounded by the partition walls 113 and including the gap 130 becomes a discharge cell into which discharge gas, including Xe, Ne, or a mixture thereof, is injected.

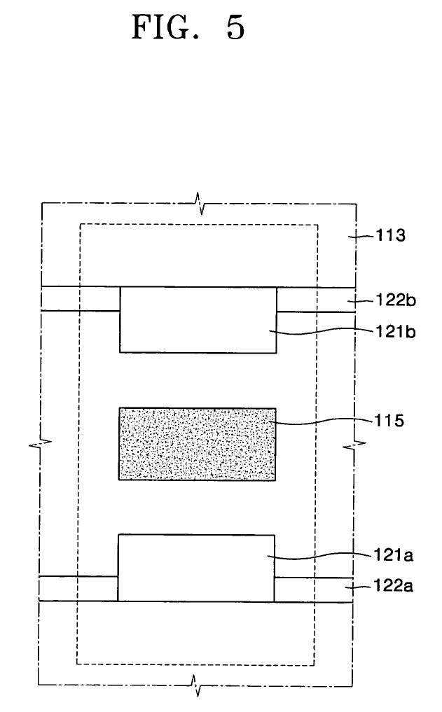

FIG. 5 is a perspective view along line I-I′ of FIG. 4. Here, FIG. 5 is a perspective view as seen from above with respect to only one discharge cell.

Referring to FIG. 5, the sustaining electrodes 121a and 121b extend in parallel with each other and are arranged in the discharge cell surrounded by the partition walls 113. The bus electrodes 122a and 122b are arranged in parallel strips on a lower surface of the sustaining electrodes 121a and 121b. The gap 130 of FIG. 4 is formed between the sustaining electrodes 121a and 121b. The fluorescent layer 115 is applied to an inner surface of the groove 132 forned on the lower surface of the front substrate 120, which is exposed to the gap 130.

The fluorescent layer 115 radiates visible rays when being irradiated by ultraviolet lays. The fluorescent layer 115 formed in a sub-pixel emitting red light be made of a fluorescent substance such as Y(V,P)O₄:Eu, etc., the fluorescent layer 115 formed in a sub-pixel emitting green light may be made of a fluorescent substance such as Zn₂SiO₄:Mn, YBO₃:Tb, etc., and the fluorescent layer 115 formed in a sub-pixel emitting blue light may be made of a fluorescent substance such as BAM:Eu, etc.

In a display panel according to an exemplary embodiment of the present invention having the above-mentioned construction, an address voltage is applied between an address electrode 111 and a Y electrode, which is one of the sustaining electrodes 121a and 121b, to generate an address discharge. The address discharge selects a discharge cell in which a sustaining discharge will occur from among the plurality of discharge cells.

Then, a sustain voltage is applied between an X electrode of the selected discharge cell and the Y electrode to generate a sustain discharge between the X electrode and the Y electrode. The sustain discharge excites the discharge gas, which emits ultraviolet rays as its energy level decreases. The ultraviolet rays excite the fluorescent layer 115 applied to the inner surface of the groove 132 formed in the gap 130 of the discharge cell, and the fluorescent layer 115 emits visible rays as its energy level decreases, thereby forming an image on the PDP.

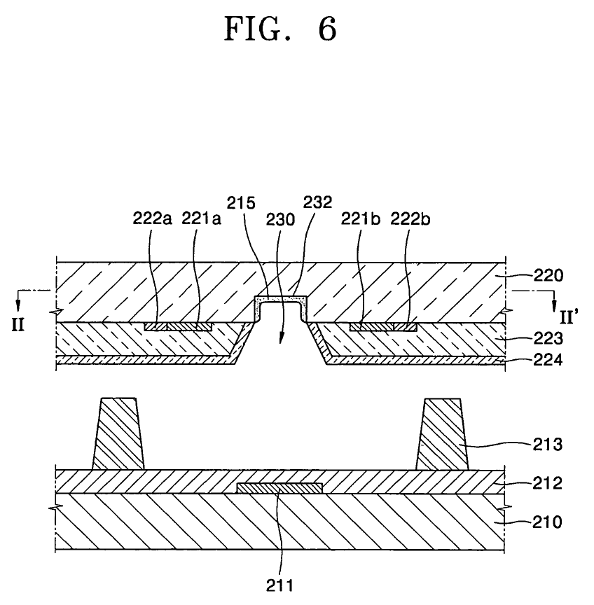

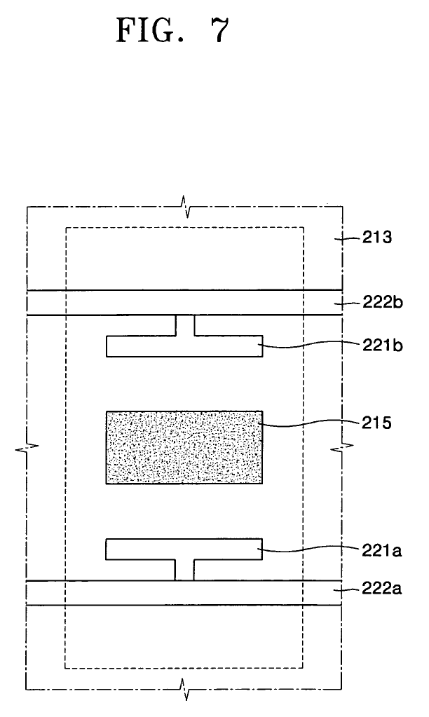

FIG. 6 and FIG. 7 show a PDP according to a second exemplary embodiment of the present invention in which the sustaining electrodes have a “T” shape, rather than a strip shape. The general structure of the PDP according to the second embodiment is similar to that of the PDP of FIG. 3, FIG. 4, and FIG. 5. In FIG. 6, the front substrate is shown rotated at an angle of 90° to better show the PDP's internal structure.

The PDP according to the second embodiment includes a rear substrate 210, a plurality of address electrodes 211 arranged on the rear substrate 210, and a lower dielectric layer 212 covering the address electrodes 211. Further, partition walls 213 are arranged on the lower dielectric layer 212 to partition a discharge space into discharge cells.

A front substrate 220 is coupled with the rear substrate 210 to form the discharge space, and a pair of sustaining electrodes 221 a and 221 b are arranged on the lower surface of the front substrate 220. The sustaining electrodes 221a and 221b are formed in the “T” shape crossing the address electrode 211.

The sustaining electrodes 221a and 221b may be made of transparent material, such as ITO, for transmitting visible rays. Metallic bus electrodes 222a and 222b are formed at the side of the sustaining electrodes 221a and 221b, in a width narrower than the protruding length of the sustaining electrodes 221a and 221b. The upper transparent dielectric layer 223 covers the sustaining electrodes 221a and 221b and bus electrodes 222a and 222b.

Since a part of the upper dielectric layer 223 may be removed by etching, the resultant surface has a ridge structure. More specifically, a part of the upper dielectric layer 223 between the pair of sustaining electrodes 221a and 221b may be etched, thereby forming a gap 230 where the upper dielectric layer 223 is removed. Consequently, the lower surface of the front substrate 220 may be exposed to the gap 230.

R, G, and B fluorescent layers 215 may be individually arranged on the lower surface of the front substrate 220 where the upper dielectric layer 223 is removed. Particularly, the lower surface of the front substrate 220 which is exposed to the gap 230 may be formed in the shape of a groove 232.

The groove 232 may be smaller than, and located within, the discharge cell. Further, the groove 232 is formed with a predetermined depth such that the fluorescent layer 215 of a predetermined thickness may be applied to an inner surface of the groove 232. Furthermore, it is preferable that the fluorescent layer 115 formed on the inner lower surface of the groove 232 and the fluorescent layer 115 formed on the inner side surfaces of the groove 232 be formed integrally with each other.

A protective layer 224 covers the upper dielectric layer 223. In this case, the protective layer 224 covers a surface of the upper dielectric layer 223 facing the rear substrate 210, as well as surfaces of the upper dielectric layer 223 forming the gap 230. The protective layer 224 prevents the upper dielectric layer 223 from being damaged due to sputtering of plasma particles and decreases a discharge voltage and a sustaining voltage by emitting secondary electrons. The protective layer 224 may be made of MgO.

FIG. 7 is a perspective view along line II-II′ of FIG. 6. Here, FIG. 7 is a perspective view as seen from above with respect to only one discharge cell.

Referring to FIG. 7, the bus electrodes 222a and 222b extend in parallel with each other and are arranged in the discharge cell surrounded by the partition walls 213. At the side of the bus electrodes 222a and 222b, “T”-shaped sustaining electrodes 221a and 221b are arranged facing each other between the bus electrodes 222a and 222b. The gap 230 of FIG. 6 is formed between the sustaining electrodes 221a and 221b. The fluorescent layer 215 is applied to an inner surface of the groove 232 formed on the lower surface of the front substrate 220, which is exposed to the gap 230.

With such a construction, a sustain discharge may smoothly occur between the sustaining electrodes 221a and 221b facing each other through the gap 230 to excite the fluorescent layer 215, which emits visible rays as its energy level decreases.

A PDP having the above-mentioned structure according to the exemplary embodiments of the present invention has advantages as described below.

Since a fluorescent layer is not formed on the lower plate, it may be possible to prevent ion impact during addressing, as well as during sustain discharging. Also, since ion impact may be prevented, it is possible to prevent the fluorescent layer from deteriorating. Further, it may be possible to prevent permanent afterimages from forming.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a rear substrate;
address electrodes arranged on the rear substrate and extending in a first direction;
a lower dielectric layer covering the address electrodes;
partition walls arranged on the lower dielectric layer to define discharge cells;
a front substrate arranged substantially in parallel with the rear substrate;
pairs of sustaining electrodes arranged on the front substrate and extending in a second direction, the second direction crossing the first direction;
an upper dielectric layer covering the sustaining electrodes;
a protective layer covering the upper dielectric layer; and
discharge gas in the discharge cells,
wherein the upper dielectric layer comprises a gap between the pairs of sustaining electrodes within the discharge cells, and a fluorescent layer is arranged in the gap.

2. The PDP of claim 1, wherein the fluorescent layer is arranged on a lower surface of the front substrate that is exposed by the gap.

3. The PDP of claim 2, wherein the exposed lower surface of the front substrate is formed in a shape of a groove.

4. The PDP of claim 3, wherein the groove is formed within the discharge cells.

5. The PDP of claim 4, wherein the fluorescent layer is arranged on an inner surface of the groove.

6. The PDP of claim 5, wherein the protective layer covers side surfaces of the upper dielectric layer forming the gap.

7. The PDP of claim 1, wherein the protective layer comprises magnesium oxide.

8. A plasma display panel (PDP), comprising:
a rear substrate;
a front substrate coupled with the rear substrate; and
a plurality of discharge cells between the front substrate and the rear substrate,
wherein a discharge cell comprises an address electrode, a sustain electrode pair, and a fluorescent layer, the fluorescent layer being arranged on the front substrate.

9. The PDP of claim 8, wherein the fluorescent layer is arranged in a groove in the front substrate.

10. The PDP of claim 9, further comprising:
a first dielectric layer comprising a gap,
wherein the sustain electrode pair is arranged on the front substrate, the first dielectric layer covers the sustain electrode pair with the gap being arranged between the sustain electrode pair, and the groove is exposed by the gap.

11. The PDP of claim 8, further comprising:
a first dielectric layer comprising a gap,
wherein the sustain electrode pair is arranged on the front substrate, the first dielectric layer covers the sustain electrode pair with the gap being arranged between the sustain electrode pair, and the fluorescent layer corresponds to the gap.

12. The PDP of claim 11, wherein the fluorescent layer is arranged in a groove in the front substrate.

13. The PDP of claim 8, further comprising:
a first dielectric layer; and
a second dielectric layer,
wherein the address electrode is arranged on the rear substrate and covered by the first dielectric layer, the sustain electrode pair is arranged on the front substrate in a direction crossing the address electrode and is covered by the second dielectric layer, and the second dielectric layer comprises a gap corresponding to the fluorescent layer.

14. The PDP of claim 13, wherein the gap and the fluorescent layer are entirely contained within the discharge cell.

15. The PDP of claim 14, wherein the fluorescent layer is arranged in a groove in the front substrate.

16. The PDP of claim 15, wherein the groove has a substantially rectangular shape.

17. The PDP of claim 15, wherein the fluorescent layer comprises a fluorescent material arranged on a lower surface and side surfaces of the groove.

18. The PDP of claim 8, wherein the fluorescent layer comprises a fluorescent layer island.
